(19) United States
(12) Patent Application Publication
(10) Pub. No.: US 2010/0109670 A1
(43) Pub. Date: May 6, 2010

(54) DETECTION SYSTEM SUITABLE FOR IDENTIFYING AND TRACKING BURIED PIPES OR OTHER BODIES BURIED IN THE GROUND OR EMBEDDED IN CIVIL ENGINEERING WORKS

(75) Inventors: Daniel Arnaud, Saint Etienne (FR); Fabian Belloir, Trepail (FR); Francois-Xavier Damour, Lyon (FR); Jean-Pierre Reyal, Eragny (FR)

Correspondence Address: CANTOR COLBURN, LLP, 20 Church Street, 22nd Floor, Hartford, CT, 06103, US

(73) Assignees: SOCIETE PLYMOUTH FRANCAISE, Feyzin (FR); IMPHY, ALLOYS, Saint Denis (FR)

(21) Appl. No.: 12/303,017

(22) PCT Filed: Jun. 1, 2007
(86) PCT No.: PCT/FR2007/000915

§ 371 Date: Jan. 11, 2010

(30) Foreign Application Priority Data
Jun. 2, 2006 (FR) 0604948

(51) Int. Cl. G01V 3/08

(52) U.S. Cl. 324/326

(57) ABSTRACT

The invention relates to a detection system suitable for identifying and tracking buried pipes or other bodies buried the ground or embedded in civil engineering works, which comprises: a coding device affixed to or integrated into the objects (1), taking the form of a succession of thin coding elements (3), each forming a surface of predetermined size, these elements being separated from one another, and their arrangement making it possible to define a code; and a detection device comprising at least one transmission coil (5), at least one reception coil (6) and a signal processing device for processing the signals coming from the various coils (5, 6), characterized in that at least some of the coding elements (3) are made of magnetic material, the detection device being designed to saturate or modify the point of operation of the coding elements (3) in their operating cycle, which then emit a frequency-rich signal made up of a wave having the fundamental frequency and waves having a frequency that is a multiple of the fundamental frequency, called harmonics, to gather and process the signal coming from these elements (3) and to reconstruct the coding of the object (1).

### BACKGROUND OF THE INVENTION

The invention relates to a detection system suitable for identifying and tracking buried pipes and conduits or other bodies buried in the ground or embedded in civil engineering works.

Civil engineering works are, for example, roads or bridges.

The difficulty in obtaining information on the presence, the layout and the nature of buried pipes, conduits or lines relates to the fact that, most of the time, nothing is visible from the outside and that existing plans often turn out to be inaccurate, incomplete, or even sometimes incorrect.

In order to save time and reduce costs, it is important to be able to detect the presence of such pipes, conduits and lines, and to locate them with precision, without digging up the ground or destroying construction works, when later work is to be carried out. Generally speaking, the methods used must be simple to implement by site personnel with modest qualifications. Furthermore, the equipment used to implement these detection methods must be robust and reliable and its cost must remain below the investment that would be required to dig up the pipes or their warning grill in order to verify their presence.

### DESCRIPTION OF THE PRIOR ART

Several methods may be used for detecting buried pipes or conduits. A first method consists in “visualizing” a buried pipe or conduit, whether metal or otherwise, with the aid of an underground radar. However, the cost and complexity of the systems implemented mean that these systems are unsuitable for the practical problems posed.

Detection by electromagnetic means is the most widely used method. This electromagnetic detection can be carried out by conventional metal detectors, electromagnetic detectors being based on the detection of a signal, and detectors associated with markers.

Conventional metal detectors detect indiscriminately all the metal items that are embedded in the ground, without differentiating between the items to be detected and extraneous items.

If the pipe or conduit is clad in a coding device comprising electrically conducting elements, such as plates or wires, disposed with a given spacing between them and mounted on an insulating medium, a detector can detect such elements, but the reading of the code may be affected by extraneous elements buried in the ground, or else by the presence nearby of several objects comprising coding elements.

Another solution consists in using electromagnetic detectors based on the detection of a signal. This solution requires the injection of an electrical signal into a pipe or into a buried cable, or into an associated metal element and following the layout of a pipe system. Such a solution has the drawback of needing to partially access the pipe or the associated metal element in order to inject the electrical signal, via units installed at regular distances on the line serving as access points.

In some cases, a passive signal detector may be used, based on the detection of an existing signal. Such is the case of the powered cables of the electricity distribution network and of the telephone network, where a current or signal is usually present. The earth also harbors numerous return currents which have a tendency to accumulate in the metal pipes and conduits. However, the detection of an unloaded powered cable is not possible since only a flowing current generates a magnetic field.

This detection is however random owing to the possibility of variable or zero loads in the case of an electricity distribution network, owing to the widespread use of pairs of cables twisted together, in such a manner that the “forward” and “return” fields tend to compensate one another.

Detectors exist that are associated with semi-active or resonant markers. The markers comprise a passive coil clad in a protective shell made of insulating material, and tuned to a certain frequency. The detector comprises an electromagnetic generator that pulses a range of frequencies and excites the coils. The drawback of such a system resides in the fact that, in order to track a pipe, markers need to be buried at regular intervals that are sufficiently close together so as not to lose the pipe, which leads to a high cost of installation. Moreover, no direction indication is given. Finally, although it may be possible to detect a pipe or conduit, identifying the latter is much more complex.

The document FR 2 819 055 describes a detection system designed for identifying and for tracking buried pipes and conduits or other bodies buried in the ground or embedded in civil engineering works, comprising:

a coding device, affixed to or integrated into the objects or placed at a pre-determined distance from the objects, taking the form of a succession of coding elements of limited thickness, each forming a surface with pre-determined dimensions, these elements being separated from one another,

a detection device comprising at least one transmission coil and at least one receiving coil,

a displacement measurement device, and

a device for processing the signals coming from the receiving coil.

The transmission of an electromagnetic wave with sufficient energy allows a wave of fundamental frequency, emitted by each coding element made of conducting material, to be obtained in return. A particular processing of the signal furthermore allows the impact of the extraneous elements in the ground to be minimized.

However, the installation of such a system does not allow the effects of the extraneous conducting elements in the ground to be completely overcome.

Moreover, although such a system has proved to be effective in certain applications, the reliability of the detection remains limited, since the response signal comprises little information, the latter being in fact composed of a single wave of fundamental frequency.

Lastly, the incorporation of such systems in warning devices can prove to be complex, notably owing to their size.

### SUMMARY OF THE INVENTION

The invention aims to solve these drawbacks by providing a detection system, designed for identifying and for tracking buried pipes and conduits or other bodies buried in the ground or embedded in civil engineering works, which is easy to use and is low cost, allowing detection, identification and reliable tracking, even in the presence of extraneous elements in the ground.

For this purpose, the subject of the invention is a detection system, designed for identifying and for tracking buried pipes and conduits or other bodies buried in the ground or embedded in civil engineering works, comprising:
a coding device, affixed to or integrated into the objects or placed at a pre-determined distance from the objects, taking the form of a succession of coding elements of limited thickness, each forming a surface with pre-determined dimensions, these elements being separated from one another,
a detection device comprising at least one transmission coil, at least one receiving coil, and
a device for processing the signals coming from the various coils,

wherein at least some of the coding elements are made from a magnetic material, the detection device being configured to saturate or modify the operating point of the coding elements within their operating cycle, which then emit a signal containing many frequencies, composed of a wave of fundamental frequency together with waves of a frequency multiple of the value of the fundamental frequency, called harmonics, to acquire and to process the signal coming from these elements, and to reconstitute the coding of the object.

The use of the magnetic properties of the coding elements forming the code allows many pieces of information to be obtained and thus the reading of the code to be made reliable.

Indeed, whereas the conventional use of conducting coding elements only allows a wave of fundamental frequency to be obtained in response, this system is based on a signal composed of both a wave of fundamental frequency together with waves of multiple frequencies, corresponding to the harmonics.

The term “multiple” should not be understood in its strict sense. Thus, a wave of multiple frequency may for example be a wave whose frequency is close to twice the fundamental frequency, but not exactly equal to this value.

Such a system furthermore allows the effect of extraneous elements, generally conducting, buried in the ground or present in the neighborhood of the object to be identified, to be overcome.

In addition, the identification of harmonic waves corresponding to a fundamental wave allows the signals emitted by the extraneous conducting elements and those emitted by the coding elements to be identified and separated.

Advantageously, the coding elements have a maximum permeability lower than 200,000, a saturation induction less than 2 Tesla and a coercive field less than 2 A/m these measurements being made under direct current.

This type of coding elements can be saturated by means of a low-energy electromagnetic wave.

Given that the detection devices are designed to be transported to the measurement area, the possibility of using a low excitation energy in order to obtain a reliable response thus enhances the portability of the detection system.

Furthermore, the magnetic extraneous elements present in the ground, which are lower in number by comparison with the conducting elements, are difficult to saturate.

Thus, if a low-energy wave is transmitted, only the coding elements will emit a response in the form of identifiable waves.

According to a first embodiment, the coding elements are made from ferromagnetic alloy of the nanocrystalline type, the nanocrystalline alloys being alloys with a composition of the type (Fe_{74.5}Si_{13.5}B₉Nb₃Cuₓ), fabricated by rapid quenching on a wheel rotating at high speed, or else alloys of the FeZrBCu type or any type of alloy with similar properties.

According to a second embodiment, the coding elements are made from alloy of the nickel-iron or cobalt-nickel-iron type, from amorphous magnetic iron-based or cobalt-based alloy.

Such materials have excellent magnetic properties and are easily saturated.

According to a third embodiment, alloys of iron-silicon type may be used, steels which however require a higher energy for their saturation.

Preferably, the coding elements are coated with films, for example of polyethylene terephthalate (PET), of polyethylene (PE) or of polyamide, with a view to creating a code system that may be unrolled along the pipe or conduit, to their protection over time and to their protection against corrosion and mechanical wear and tear.

According to one feature of the invention, the coding elements comprise several layers of different magnetic materials.

Such an arrangement allows the information that can be obtained by each coding element to be increased, in order to densify the coding.

According to one alternative feature, the coding elements comprise at least one layer of magnetic material and at least one layer of conducting material.

This feature allows the magnetic properties of the coding elements to be used while, at the same time, also combining this with a detection using eddy currents.

Advantageously, the coding elements, designed to equip a longitudinal body of the pipe or conduit type, come in the form of elongated tags, the coding elements being spaced out with respect to one another along the axis of the body and oriented along this axis and/or forming an angle with the latter.

Such a disposition of the coding elements along the body allows an identifiable code to be formed that facilitates tracking of the body by the user.

According to one feature, the coding elements come in various forms and/or various dimensions.

The shape and the size of the elements allow densification of the information to be achieved, thus offering a greater number of coding possibilities.

According to one possibility, the coding elements comprise at least one layer of paint with a ferrite and/or nanocrystalline alloy powder base.

In any event, the invention will be better understood by means of the description that follows, with reference to the appended schematic drawing showing, by way of non-limiting examples, several embodiments of this system.

### BRIEF DESCRIPTION OF THE DRAWINGS

FIG. 1 is a view of a section of pipe equipped with coding elements, in the buried position and during a detection phase;

FIG. 2 is a perspective view showing the transmission and receiving coils disposed according to a first variant embodiment;

FIGS. 3 and 4 are views, corresponding to FIG. 2, of a second and of a third embodiment, respectively;

FIGS. 5 to 12 are views showing a part of the pipe or conduit equipped with coding elements according to various embodiments of the invention.

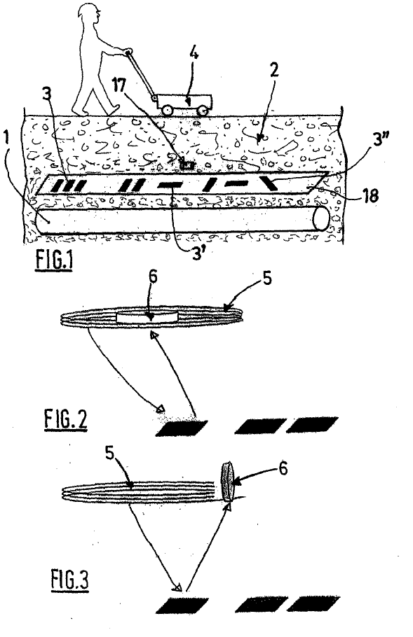

FIG. 1 describes a pipe or conduit 1 buried in the earth 2. A strip composed of a plurality of magnetic coding elements 3, 3′ and 3″, bonded between two polymer strips, is disposed at a pre-determined distance above this pipe 1. As indicated in the diagram, this strip is buried in the ground.

The detection, identification and tracking system comprises a support 4 which can be displaced by a user over the surface comprising at least one transmission or excitation coil 5, at least one receiving coil 6, a device for processing the signals coming from the receiving coil 6 and at least one system for determining the position, the direction of the motion and the speed of the assembly.

Preferably, a coding wheel is used in order to determine the spatial position of the detection system.

The transmission coil 5 is preferably a flat coil which allows the coding elements 3 to be more easily saturated whatever their orientation. It is furthermore preferred that it is parallel to the coding elements 3, 3′ and 3″ in order to increase the intensity of the signal.

### DESCRIPTION OF THE PREFERRED EMBODIMENTS

According to a first embodiment shown in FIG. 2, each receiving coil 6 is disposed parallel to the corresponding transmission coil 5 and within the shadow region of the latter, in other words substantially in the center of the latter.

According to a second embodiment shown in FIG. 3, the receiving coil 6 is disposed perpendicularly to the transmission coil 5 and to the axis of the pipe 1.

There could also be several receiving coils 6 associated with each transmission coil 5.

According to a third embodiment shown in FIG. 4, the system comprises at least one transmission coil 5 disposed in parallel with the coding elements 3, in other words in the XOY plane, and associated with at least two receiving coils 6 and 6′, disposed for example on either side of the transmission coil, the receiving coil 6 being disposed in the plane parallel to the XOZ plane and the coil 6′ being disposed in a plane parallel to the YOZ plane.

The combination of the receiving coil 5 and the receiving coil or receiving coils 6 then forms an electromagnetic detector based on the principle of induction balance.

The invention aims to use the magnetic properties of the coding elements 3, 3′ and 3″.

For this purpose, an electromagnetic wave of given frequency and energy is sent into the ground 2, in the direction of the pipe 1, in order to reach the coding elements 3.

The ground comprises a plurality of extraneous elements 17, generally composed of conducting materials and/or magnetic materials that are difficult to saturate.

The frequency, which will be referred to as fundamental and which will be denoted f₀, and the energy of the transmitted wave are adapted according to the intrinsic properties of the material used and to the depth of the element. This frequency and this energy are used to excite each magnetic coding element 3, 3′ and 3″ in such a manner as to bring the element into a state close to saturation.

It is recalled that the saturation state of a magnetic element is the state in which it is subjected to an external magnetic field whose intensity is so high that the magnetic induction cannot be appreciably increased by raising the intensity of this field. This state thus corresponds to the state of maximum magnetization of the element.

The coding elements subjected to such a saturation then emit a wave of fundamental frequency f₀ together with a plurality of waves with multiple frequencies 2f₀, 3f₀, . . . , nf₀ corresponding to the harmonics.

This signal is subsequently acquired by the receiving coil or coils then transmitted to the processing device.

In other words, the transmission coil, through which an alternating current with a frequency fₒ equal to, for example, 10 kHz is flowing, generates an excitation magnetic field that is strong enough to saturate the coding elements 3, 3′ and 3″ of the tag type. The technical characteristics of these tags are described hereinafter.

This saturation results in a deformation of the emitted signal and in the creation of the harmonics characterizing the operating point of the tags 3, 3′ and 3″.

The receiving coils 6 and 6′ are optionally placed within regions known as “shadow regions” and are tuned to the desired frequencies, detect the variation in the magnetic field generated by the transmission coil 5 due to the presence of the tags 3 and 3′. It should be noted that a shadow region is defined as being the region where the total flux of the magnetic field of frequency f₀ generated by the transmission coil in the receiving coil is very low, or even zero, in the absence of a target, in other words of a coding element or tag 3 or 3′. The frequencies used are generally the second (2f₀) and the third (3f₀) harmonics.

In addition, aside from exploiting the non-linear magnetic characteristics of the materials of the tags, the system according to the invention is also capable of exploiting the fact that the thin and long tags have an easy magnetization direction in the long direction of the tags.

The orientation of the coils 6 and 6′ depends on that of the tags 3 and 3′ to be detected. With each type of tag, in other words for each orientation of the tags, is associated at least one receiving coil 6 or 6′ whose plane is orthogonal to the orientation of the tag 3 or 3′. This allows a maximum magnetic flux to be detected corresponding to each “coil-tag type” pair.

Each type of coil thus individually reads one type of tag. However, the tags of another type also send a signal into each receiving coil. This interfering signal is minimized when the detection system is aligned on the tags 3 or 3′, by the choice of setting the normal to the plane of a receiving coil parallel to the axis of symmetry of one type of tag. The receiving coils then mainly see the tags that are orthogonal to them.

The structure and the position of the various coils additionally have the following advantages. The magnetic field generated by the transmission coil is a conventional field generated by a conventional flat coil. Thus, it is irrelevant that the coding element in the form of a tag passes within a region of zero magnetic field, in other words near to or within the transmission coil. It suffices simply that the coding element is excited by an alternating magnetic field so as to saturate it.

A first harmonic frequency, for example 2f₀, may also be associated with a type of tag and another harmonic frequency, for example 3f₀ or nf₀ with another type of tag.

The tags can then be differentiated, and phase and amplitude information obtained by means of the receiving coils, which information will be able to be processed separately for each class of tag 3 or 3′.

The signals characteristic of the codes are obtained by comparison, typically a synchronous detection in which the reception of the signal is effected in synchronization with the transmission, between the signal transmitted by the transmission coils and the signal received by the receiving coils.

It should be noted that any other known method of comparison could equally be used.

The presence of the magnetic coding elements modifies the received signal, which allows the presence and the nature of the elements to be detected.

The signal emitted, composed of both a wave at the fundamental frequency and of waves corresponding to the harmonics, allows the coding density, in other words the amount of information, to be increased after processing of the signal. The reliability of reading of the corresponding code and hence of the detection is thus considerably enhanced.

In the case of the juxtaposition of various separate codes or of the presence of interfering magnetic elements, the signals characteristic of the codes are affected. However, thanks to the redundancy of information due to the use of source separation algorithms and, if necessary, to the use of several receiving coils associated with each transmission coil, it is possible to reconstruct the true signal representative of the code.

It then suffices to identify the signal that represents the signature of the code by various shape recognition and classification methods, of the neural networks or fuzzy logic type and other conventional methods.

The final response is obtained by the implementation of decision-aid processes which analyze the responses of each of the aforementioned methods.

This type of processing of the signal produced by the receiving coils is described in more detail in the article “BELLOIR F., HUEZ R., BILLAT A., 2000; A smart flat-coil eddy-current sensor for metal-tag recognition; Measurement Science & Technology; vol. 11, no 4, pp. 367-374”.

The system according to the invention thus enables pipes or conduits buried up to a depth of 2 m to be detected.

The composition and the positioning of the coding elements 3 and 3′ on the longitudinal body 1 will now be detailed.

These coding elements 3 are formed from a soft magnetic material preferably exhibiting a permeability lower than 200,000, a saturation induction less than 2 Tesla and a coercive field less than 1 A/m.

According to a first possibility, the elements of 3 are made from alloy of the nickel-iron or cobalt-iron type, from amorphous magnetic iron-based or cobalt-based alloy, from alloy of the iron-silicon type or made from steel.

Alloys of the nickel-iron type that are particularly attractive for their high permeability are permalloy and mu-metal.

According to another possibility, the coding elements 3 have a strip of nanocrystalline alloys disposed between two sheets of polymer of the polyethylene terephthalate (PET), polyethylene (PE), polyamide or other type.

In this case, the permeability of the material is around 200,000, the saturation induction is high, substantially around 1.2 T, and the coercive field is low, less than 2 A/m. In addition, such coding elements 3 made from nanocrystalline material can be used with a low transmission frequency, lower than 1 MHz and for example of the order of 10 kHz.

These coding elements thus come in the form of tags that preferentially magnetize in the direction of their length, which is the easy magnetization direction. As is described hereinafter, these tags can be placed parallel to the displacement of the electromagnetic detector, orthogonal to this displacement, or else at a given angle with respect to the latter.

Magnetic paints composed of a solvent, a polymer binder and magnetic powders may also be used. In this case, the powders can be either ferrite powders or powders of nanocrystalline alloys. These two types of powder have the advantage of being able to work with a signal of higher frequency, but cannot be buried at a great depth.

The coding elements 3 and 3′ may also be fabricated in the form of layers of different magnetic materials, or even comprise layers of conducting material.

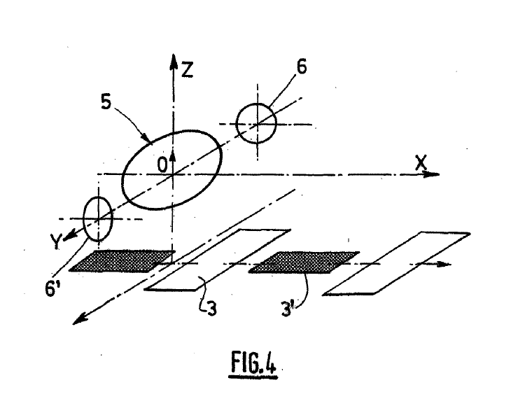

FIGS. 5 to 12 present some of the embodiments that may be envisioned with regard to the positioning, the shape and the choice of the coding elements.

Thus, according to an embodiment appearing in FIG. 5, the coding elements 3 and 3′ come in the form of elongated tags, the coding elements being spaced out with respect to one another along the axis of the body 1, some of the elements 3 being oriented along this axis, others 3′ being oriented perpendicularly to the latter and yet others 3″ being oriented at another angle with respect to the axis defined by the body 1.

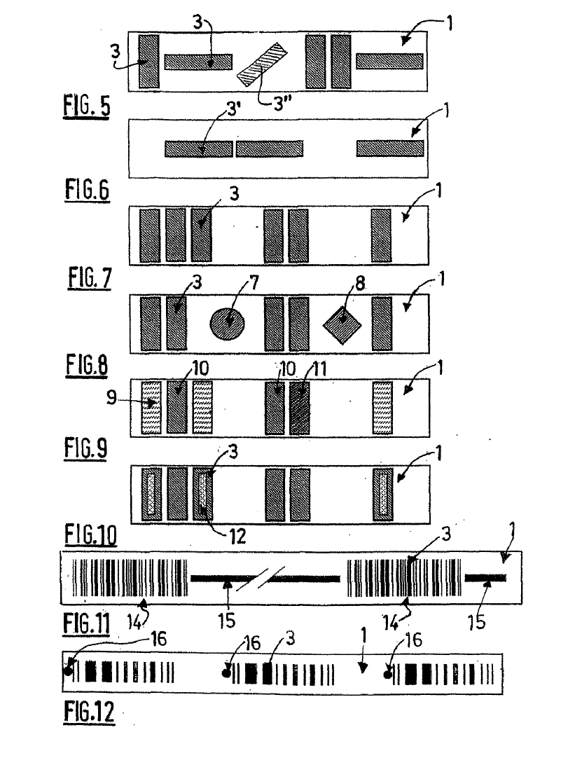

Alternatively, the coding elements 3 are only oriented along the axis of the pipe 1 (FIG. 6) or only perpendicular with respect to the latter (FIG. 7).

According to another embodiment, shown in FIG. 8, some of the coding elements have a different shape, for example circular 7 or polygonal 8.

As can be seen in FIG. 9, the coding elements may be formed from several different magnetic materials.

The advantage of such a device resides in the fact that, by transmitting a signal with a varying intensity, each group of coding elements having the same magnetic properties is able to be selectively driven into saturation.

In this way, the possibilities for containing information within such a code are increased.

Take the example of a code composed of three groups 9, 10, 11 of coding elements, each one being formed from a different material in such a manner that each group has a different saturation induction, B1, B2 and B3, respectively, with B1>B2>B3.

In this case, depending on the intensity of the magnetic field, the first two groups 9, 10 can be saturated without saturating the third 11.

The response will then be composed only of harmonics of the first two groups 9, 10.

As shown in FIG. 10, another variant consists in providing a code composed of coding elements 3 formed from the same magnetic material, some of the elements being covered by a strip of conducting material 12.

These strips 12 are for example made of copper and have a thickness of 20 microns. The latter are furthermore electrically isolated from the magnetic material.

FIG. 11 shows codes 14 composed of coding elements 3 and spaced out for example by 10 meters. These codes are linked by intermediate strips or wires 15 formed from magnetic material.

These strips or wires 15 allow the pipe or conduit to be tracked as far as the corresponding code.

According to one additional variant shown in FIG. 12, permanent magnets 16, that are particularly easy to identify, can be disposed at the start of a code in order to identify, if required, the beginning and/or orientation of the buried pipe or conduit 1.

It goes without saying that the invention is not limited only to the embodiments of this system described hereinabove by way of example but, on the contrary, it encompasses all the variants. Thus, in particular this device could also be used for the detection and the location of notable points, such as the position of branch pipes.

1. A detection system, designed for identifying and for tracking buried pipes and conduits or other bodies buried in the ground or embedded in civil engineering works, comprising:
a coding device, affixed to or integrated into the objects or placed at a pre-determined distance from the objects, taking the form of a succession of coding elements of limited thickness, each forming a surface with pre-determined dimensions, these elements being separated from one another, and their arrangement allowing a code to be defined,
a detection device comprising at least one transmission coil, at least one receiving coil, and
a device for processing the signals coming from the various coils,
wherein at least some of the coding elements are made from a magnetic material, the detection device being configured to saturate or modify the operating point of the coding elements within their operating cycle, which then emit a signal containing many frequencies, composed of a wave of fundamental frequency together with waves of a frequency multiple of the value of the fundamental frequency, called harmonics, to acquire and to process the signal coming from these elements, and to reconstitute the coding of the object.

2. The system as claimed in claim 1, wherein the coding elements have a permeability lower than 200,000, a saturation induction less than 2 Tesla and a coercive field less than 1 A/m.

3. The system as claimed in claim 1, wherein the coding elements are made from ferromagnetic alloy of the nano crystalline type.

4. The system as claimed in claim 3, wherein the alloy has a composition of the type (Fe_{74.5}Si_{13.5}B9Nb₃Cuₓ), fabricated by rapid quenching on a wheel rotating at high speed, or else alloys of the FeZrBCu type.

5. The system as claimed in claim 1, wherein the coding elements are made from alloy of the nickel-iron or cobalt-iron type, from amorphous magnetic iron-based or cobalt-based alloy, from alloy of the iron-silicon type or made from steel.

6. The system as claimed in claim 1, wherein the coding elements are coated with films, for example of polyethylene terephthalate (PET), of polyethylene (PE) or of polyamide.

7. The system as claimed in claim 1, wherein the coding elements comprise several layers of different magnetic materials.

8. The system as claimed in claim 1, wherein the coding elements comprise at least one layer of magnetic material and at least one layer of conducting material.

9. The system as claimed in claim 1, wherein the coding elements, designed to equip a longitudinal body of the pipe or conduit type, come in the form of elongated tags, the coding elements being spaced out with respect to one another along the axis of the body and oriented along this axis and/or forming an angle with the latter.

10. The system as claimed in claim 1, wherein the coding elements come in various forms and/or various dimensions.

11. The system as claimed in claim 10, wherein the coding elements comprise at least one magnetic strip or wire.

12. The system as claimed in claim 1, wherein the coding elements comprise at least one layer of paint with a ferrite and/or nanocrystalline alloy powder base.
